(19) United States
(12) Patent Application Publication
(10) Pub. No.: US 2026/0282024 A1
(43) Pub. Date: Sep. 17, 2026

(54) MAPPING UPLINK CONTROL INFORMATION

(71) Applicant: Nokia Technologies Oy, Espoo (FI)

(72) Inventors: Nhat-Quang NHAN, Reims (FR); Jing Yuan SUN, Beijing (CN); Youngsoo YUK, Seoul (KR); Erika PORTELA LOPES DE ALMEIDA, Aalborg (DK)

(21) Appl. No.: 19/473,429

(22) PCT Filed: Apr. 14, 2023
(86) PCT No.: PCT/CN2023/088522

§ 371 Date: Oct. 7, 2025

(51) Int. Cl. H04W 72/21; H04L 5/00; H04W 72/0453

(52) U.S. Cl. CPC H04W 72/21; H04L 5/0044; H04W 72/0453

(57) ABSTRACT

Disclosed is a method comprising receiving an indication indicating to map uplink control information on a physical uplink shared channel, PUSCH, at one or more slots, wherein the one or more slots are configured for a sub-band full duplex, SBFD, operation; determining a number of resource blocks in allocated resource blocks of the PUSCH that are within a pre-defined distance from one or more downlink subbands or one or more guard bands in frequency domain; determining, based on the number of resource blocks, at least one frequency resource range where at least a subset of the uplink control information should not be mapped; mapping the at least subset of the uplink control information on the PUSCH such that the at least subset of the uplink control information is not mapped to the at least one frequency resource range; and transmitting the PUSCH.

### FIELD

The following example embodiments relate to wireless communication.

### BACKGROUND

Cross-link interference refers to the undesired interference between two separate communication links in a wireless communication system. This interference may occur when the signal from one link, which is intended for a specific receiver, interferes with another link, causing a degradation of the communication quality or performance. It is desirable to protect the links from cross-link interference.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions that, when executed by the at least one processor, cause the apparatus at least to: receive an indication indicating to map uplink control information on a physical uplink shared channel at one or more slots, wherein the one or more slots are configured for a sub-band full duplex, SBFD, operation; determine, based on at least one default number of resource blocks or at least one scaling factor, a number of resource blocks in allocated resource blocks of the physical uplink shared channel that are within a pre-defined distance from one or more downlink subbands or one or more guard bands in frequency domain; determine, based on the number of resource blocks, at least one frequency resource range where at least a subset of the uplink control information should not be mapped; map the at least subset of the uplink control information on the physical uplink shared channel such that the at least subset of the uplink control information is not mapped to the at least one frequency resource range; and transmit the physical uplink shared channel according to the mapping at the one or more slots.

According to another aspect, there is provided an apparatus comprising: means for receiving an indication indicating to map uplink control information on a physical uplink shared channel at one or more slots, wherein the one or more slots are configured for a sub-band full duplex, SBFD, operation; means for determining, based on at least one default number of resource blocks or at least one scaling factor, a number of resource blocks in allocated resource blocks of the physical uplink shared channel that are within a pre-defined distance from one or more downlink subbands or one or more guard bands in frequency domain; means for determining, based on the number of resource blocks, at least one frequency resource range where at least a subset of the uplink control information should not be mapped; means for mapping the at least subset of the uplink control information on the physical uplink shared channel such that the at least subset of the uplink control information is not mapped to the at least one frequency resource range; and means for transmitting the physical uplink shared channel according to the mapping at the one or more slots.

According to another aspect, there is provided a method comprising: receiving an indication indicating to map uplink control information on a physical uplink shared channel at one or more slots, wherein the one or more slots are configured for a sub-band full duplex, SBFD, operation; determining, based on at least one default number of resource blocks or at least one scaling factor, a number of resource blocks in allocated resource blocks of the physical uplink shared channel that are within a pre-defined distance from one or more downlink subbands or one or more guard bands in frequency domain; determining, based on the number of resource blocks, at least one frequency resource range where at least a subset of the uplink control information should not be mapped; mapping the at least subset of the uplink control information on the physical uplink shared channel such that the at least subset of the uplink control information is not mapped to the at least one frequency resource range; and transmitting the physical uplink shared channel according to the mapping at the one or more slots.

According to another aspect, there is provided a computer program comprising instructions which, when executed by an apparatus, cause the apparatus to perform at least the following: receiving an indication indicating to map uplink control information on a physical uplink shared channel at one or more slots, wherein the one or more slots are configured for a sub-band full duplex, SBFD, operation; determining, based on at least one default number of resource blocks or at least one scaling factor, a number of resource blocks in allocated resource blocks of the physical uplink shared channel that are within a pre-defined distance from one or more downlink subbands or one or more guard bands in frequency domain; determining, based on the number of resource blocks, at least one frequency resource range where at least a subset of the uplink control information should not be mapped; mapping the at least subset of the uplink control information on the physical uplink shared channel such that the at least subset of the uplink control information is not mapped to the at least one frequency resource range; and transmitting the physical uplink shared channel according to the mapping at the one or more slots.

According to another aspect, there is provided a computer readable medium comprising program instructions which, when executed by an apparatus, cause the apparatus to perform at least the following: receiving an indication indicating to map uplink control information on a physical uplink shared channel at one or more slots, wherein the one or more slots are configured for a sub-band full duplex, SBFD, operation; determining, based on at least one default number of resource blocks or at least one scaling factor, a number of resource blocks in allocated resource blocks of the physical uplink shared channel that are within a pre-defined distance from one or more downlink subbands or one or more guard bands in frequency domain; determining, based on the number of resource blocks, at least one frequency resource range where at least a subset of the uplink control information should not be mapped; mapping the at least subset of the uplink control information on the physical uplink shared channel such that the at least subset of the uplink control information is not mapped to the at least one frequency resource range; and transmitting the physical uplink shared channel according to the mapping at the one or more slots.

According to another aspect, there is provided a non-transitory computer readable medium comprising program instructions which, when executed by an apparatus, cause the apparatus to perform at least the following: receiving an indication indicating to map uplink control information on a physical uplink shared channel at one or more slots, wherein the one or more slots are configured for a sub-band full duplex, SBFD, operation; determining, based on at least one default number of resource blocks or at least one scaling factor, a number of resource blocks in allocated resource blocks of the physical uplink shared channel that are within a pre-defined distance from one or more downlink subbands or one or more guard bands in frequency domain; determining, based on the number of resource blocks, at least one frequency resource range where at least a subset of the uplink control information should not be mapped; mapping the at least subset of the uplink control information on the physical uplink shared channel such that the at least subset of the uplink control information is not mapped to the at least one frequency resource range; and transmitting the physical uplink shared channel according to the mapping at the one or more slots.

According to another aspect, there is provided an apparatus comprising at least one processor, and at least one memory storing instructions that, when executed by the at least one processor, cause the apparatus at least to: transmit, to a user device, an indication indicating to map uplink control information on a physical uplink shared channel at one or more slots, wherein the one or more slots are configured for a sub-band full duplex, SBFD, operation; transmit, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and receive, from the user device, the physical uplink shared channel, wherein at least a subset of the uplink control information is mapped on the physical uplink shared channel, wherein the at least subset of the uplink control information is not mapped in the number of resource blocks.

According to another aspect, there is provided an apparatus comprising: means for transmitting, to a user device, an indication indicating to map uplink control information on a physical uplink shared channel at one or more slots, wherein the one or more slots are configured for a sub-band full duplex, SBFD, operation; means for transmitting, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and means for receiving, from the user device, the physical uplink shared channel, wherein at least a subset of the uplink control information is mapped on the physical uplink shared channel, wherein the at least subset of the uplink control information is not mapped in the number of resource blocks.

According to another aspect, there is provided a method comprising: transmitting, to a user device, an indication indicating to map uplink control information on a physical uplink shared channel at one or more slots, wherein the one or more slots are configured for a sub-band full duplex, SBFD, operation; transmitting, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and receiving, from the user device, the physical uplink shared channel, wherein at least a subset of the uplink control information is mapped on the physical uplink shared channel, wherein the at least subset of the uplink control information is not mapped in the number of resource blocks.

According to another aspect, there is provided a computer program comprising instructions which, when executed by an apparatus, cause the apparatus to perform at least the following: transmitting, to a user device, an indication indicating to map uplink control information on a physical uplink shared channel at one or more slots, wherein the one or more slots are configured for a sub-band full duplex, SBFD, operation; transmitting, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and receiving, from the user device, the physical uplink shared channel, wherein at least a subset of the uplink control information is mapped on the physical uplink shared channel, wherein the at least subset of the uplink control information is not mapped in the number of resource blocks.

According to another aspect, there is provided a computer readable medium comprising program instructions which, when executed by an apparatus, cause the apparatus to perform at least the following: transmitting, to a user device, an indication indicating to map uplink control information on a physical uplink shared channel at one or more slots, wherein the one or more slots are configured for a sub-band full duplex, SBFD, operation; transmitting, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and receiving, from the user device, the physical uplink shared channel, wherein at least a subset of the uplink control information is mapped on the physical uplink shared channel, wherein the at least subset of the uplink control information is not mapped in the number of resource blocks.

According to another aspect, there is provided a non-transitory computer readable medium comprising program instructions which, when executed by an apparatus, cause the apparatus to perform at least the following: transmitting, to a user device, an indication indicating to map uplink control information on a physical uplink shared channel at one or more slots, wherein the one or more slots are configured for a sub-band full duplex, SBFD, operation;
transmitting, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and receiving, from the user device, the physical uplink shared channel, wherein at least a subset of the uplink control information is mapped on the physical uplink shared channel, wherein the at least subset of the uplink control information is not mapped in the number of resource blocks.

### LIST OF DRAWINGS

In the following, various example embodiments will be described in greater detail with reference to the accompanying drawings, in which

FIG. 1 illustrates an example of a wireless communication network;

FIG. 2 illustrates an example of physical uplink shared channel repetition type A;

FIG. 3 illustrates an example of physical uplink shared channel repetition type A;

FIG. 4 illustrates an example of power spectral density gain offered by transport block processing over multiple slots;

FIG. 5A illustrates an example of consecutive slot allocation for transport block processing over multiple slots;

FIG. 5B illustrates an example of non-consecutive slot allocation for transport block processing over multiple slots;

FIG. 6 illustrates an example of repetitions of transport block processing over multiple slots;

FIG. 7A illustrates an example of mapping hybrid automatic repeat request acknowledgement information on a physical uplink shared channel;

FIG. 7B illustrates an example of mapping channel state information on a physical uplink shared channel;

FIG. 7C illustrates an example of mapping uplink data on a physical uplink shared channel;

FIG. 8 illustrates an example of frequency-time resource partitioning with subband full duplex as compared to frequency-division duplexing and time-division duplexing;

FIG. 9 illustrates an example of subband full duplex slots and non-subband full duplex slots;

FIG. 10A illustrates examples of co-channel interference types;

FIG. 10B illustrates examples of co-channel interference types;

FIG. 11 illustrates a signal flow diagram;

FIG. 12 illustrates a flow chart;

FIG. 13 illustrates a flow chart;

FIG. 14 illustrates an example of determining at least one frequency resource range, where uplink control information should not be mapped;

FIG. 15 illustrates an example of setting different resource block sets in uplink subband;

FIG. 16 illustrates an example of an apparatus; and

FIG. 17 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Some example embodiments described herein may be implemented in a wireless communication network comprising a radio access network based on one or more of the following radio access technologies: Global System for Mobile Communications (GSM) or any other second generation radio access technology, Universal Mobile Telecommunication System (UMTS, 3G) based on basic wideband-code division multiple access (W-CDMA), high-speed packet access (HSPA), Long Term Evolution (LTE), LTE-Advanced, fourth generation (4G), fifth generation (5G), 5G new radio (NR), 5G-Advanced (i.e., 3GPP NR Rel-18 and beyond), or sixth generation (6G). Some examples of radio access networks include the universal mobile telecommunications system (UMTS) radio access network (UTRAN), the Evolved Universal Terrestrial Radio Access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications.

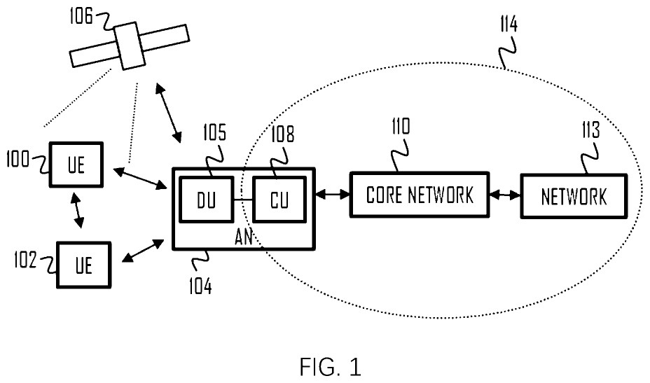

FIG. 1 depicts an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the embodiments described herein to other wireless communication networks provided with necessary properties.

The example wireless communication network shown in FIG. 1 includes an access network, such as a radio access network (RAN), and a core network 110.

FIG. 1 shows user equipment (UE) 100, 102 configured to be in a wireless connection on one or more communication channels in a radio cell with an access node (AN) 104 of an access network. The AN 104 may be an evolved Node B (abbreviated as eNB or eNodeB) or a next generation Node B (abbreviated as gNB or gNodeB), providing the radio cell. The wireless connection (e.g., radio link) from a UE to the access node 104 may be called uplink (UL) or reverse link, and the wireless connection (e.g., radio link) from the access node to the UE may be called downlink (DL) or forward link. UE 100 may also communicate directly with UE 102, and vice versa, via a wireless connection generally referred to as a sidelink (SL). It should be appreciated that the access node 104 or its functionalities may be implemented by using any node, host, server or access point etc. entity suitable for providing such functionalities.

The access network may comprise more than one access node, in which case the access nodes may also be configured to communicate with one another over links, wired or wireless. These links between access nodes may be used for sending and receiving control plane signaling and also for routing data from one access node to another access node.

The access node may comprise a computing device configured to control the radio resources of the access node. The access node may also be referred to as a base station, a base transceiver station (BTS), an access point, a cell site, a radio access node or any other type of node capable of being in a wireless connection with a UE (e.g., UEs 100, 102). The access node may include or be coupled to transceivers. From the transceivers of the access node, a connection may be provided to an antenna unit that establishes bi-directional radio links to UEs 100, 102. The antenna unit may comprise an antenna or antenna element, or a plurality of antennas or antenna elements.

The access node 104 may further be connected to a core network (CN) 110. The core network 110 may comprise an evolved packet core (EPC) network and/or a 5th generation core network (5GC). The EPC may comprise network entities, such as a serving gateway (S-GW for routing and forwarding data packets), a packet data network gateway (P-GW) for providing connectivity of UEs to external packet data networks, and a mobility management entity (MME). The 5GC may comprise network functions, such as a user plane function (UPF), an access and mobility management function (AMF), and a location management function (LMF).

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device just to mention but a few names. The UE may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or any computing device comprising a wireless modem integrated in a vehicle.

It should be appreciated that a UE may also be a nearly exclusive uplink-only device, of which an example may be a camera or video camera loading images or video clips to a network. A UE may also be a device having capability to operate in an Internet of Things (IOT) network, which is a scenario in which objects may be provided with the ability to transfer data over a network without requiring human-to-human or human-to-computer interaction. The UE may also utilize cloud. In some applications, the computation may be carried out in the cloud or in another UE.

The wireless communication network may also be able to support the usage of cloud services, for example at least part of core network operations may be carried out as a cloud service (this is depicted in FIG. 1 by “cloud” 114). The wireless communication network may also comprise a central control entity, or the like, providing facilities for wireless communication networks of different operators to cooperate for example in spectrum sharing.

5G enables using multiple input-multiple output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine type applications, such as (massive) machine-type communications (mMTC), including vehicular safety, different sensors and real-time control.

In 5G wireless communication networks, access nodes and/or UEs may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, a 5G wireless communication network may support both inter-RAT operability (such as LTE-5G) and inter-RI operability (inter-radio interface operability, such as below 6 GHz-cmWave-mmWave). One of the concepts considered to be used in 5G wireless communication networks may be network slicing, in which multiple independent and dedicated virtual sub-networks (network instances) may be created within the substantially same infrastructure to run services that have different requirements on latency, reliability, throughput and mobility.

In some example embodiments, an access node (e.g., access node 104) may comprise: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node. The DU 105 may be a logical node hosting radio link control (RLC), medium access control (MAC) and/or physical (PHY) layers of the NR protocol stack for the access node. The operations of the DU may be at least partly controlled by the CU. It should also be understood that the distribution of functions between DU 105 and CU 108 may vary depending on implementation. The CU may comprise a control plane (CU-CP), which may be a logical node hosting the RRC and the control plane part of the PDCP protocol of the NR protocol stack for the access node. The CU may further comprise a user plane (CU-UP), which may be a logical node hosting the user plane part of the PDCP protocol and the SDAP protocol of the CU for the access node.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the access network (e.g., RAN) by utilizing network function virtualization (NFV) and software defined networking (SDN). Using edge cloud may mean access node operations to be carried out, at least partly, in a computing system operationally coupled to a remote radio head (RRH) or a radio unit (RU) of an access node. It is also possible that access node operations may be performed on a distributed computing system or a cloud computing system located at the access node. Application of cloud RAN architecture enables RAN real-time functions being carried out at the access network (e.g., in a DU 105) and non-real-time functions being carried out in a centralized manner (e.g., in a CU 108).

It should also be understood that the distribution of functions between core network operations and access node operations may differ in future wireless communication networks compared to that of the LTE or 5G, or even be non-existent. Some other technology advancements that may be used include big data and all-IP, which may change the way wireless communication networks are being constructed and managed. 5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network, enabling more extensive network coverage. Possible use cases may be providing service continuity for machine-to-machine (M2M) or Internet of Things (IOT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay access node or by an access node 104 located on-ground or in a satellite.

It is obvious for a person skilled in the art that the access node 104 depicted in FIG. 1 is just an example of a part of an access network (e.g., a radio access network) and in practice, the access network may comprise a plurality of access nodes, the UEs 100, 102 may have access to a plurality of radio cells, and the access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of an access network (e.g., a radio access network), a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of access networks, the concept of “plug-and-play” access nodes may be introduced. An access network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's access network, may aggregate traffic from a large number of Home eNodeBs or Home gNodeBs back to a core network of the operator.

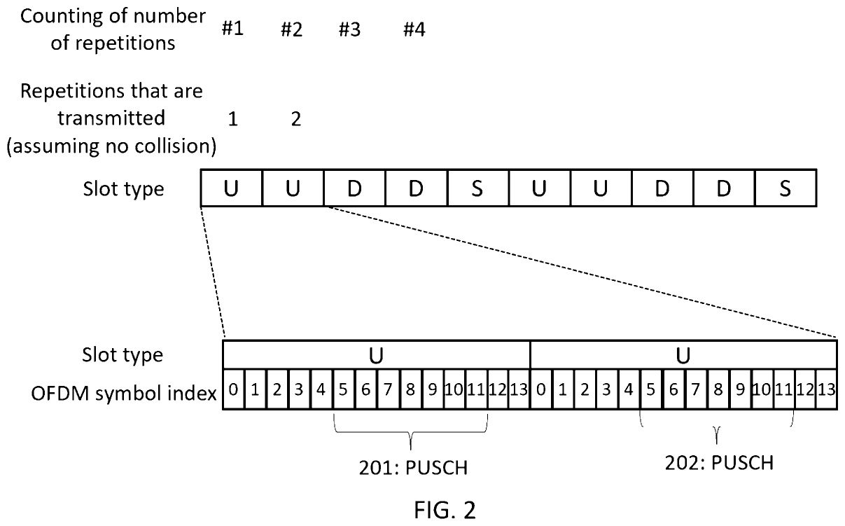

NR Rel-15 introduces a slot aggregation feature for physical uplink shared channel (PUSCH), wherein this slot aggregation feature is also known as PUSCH repetition type A. In PUSCH repetition type A, transmission of a transport block (TB) is repeated in multiple slots. The same number of allocated resource blocks is applied across the PUSCH repetitions. Each repetition is in a slot (i.e., time slot). A single start and length of a PUSCH within a slot may be indicated, i.e., a single start and length indicator value (SLIV). The same start and length indicated by the single SLIV may be applied across all PUSCH repetitions. In NR Rel-15, the number of repetitions for PUSCH repetition type A is semi-statically configured in RRC and the number of repetitions is counted on consecutive physical slots, as illustrated in FIG. 2. If the number of available symbols in a slot is not sufficient (i.e., less than the length of the PUSCH), PUSCH repetition is not transmitted in the slot.

FIG. 2 illustrates an example of PUSCH repetition type A in NR Rel-15 with 4 repetitions, wherein the PUSCH repetitions 201, 202 in a given slot start from symbol number 5 and the length of a given PUSCH repetition 201, 202 is 7 symbols, assuming a DDSUU (10D: 2G: 2U) time-division duplexing (TDD) pattern. Herein the symbols refer to orthogonal frequency-division multiplexing (OFDM) symbols. In FIG. 2, “D” denotes a downlink slot, “S” denotes a special slot, and “U” denotes an uplink slot.

The DDSUU (10D: 2G: 2U) TDD pattern represents a specific TDD configuration where two downlink slots, one special slot (or guard period), and two uplink slots are arranged in a sequence, where the special slot consists of ten downlink symbols, two guard symbols, and two uplink symbols arranged in a sequence. The guard symbols are used by the UE 100, 102 as switching time for switching from downlink reception to uplink transmission.

NR Rel-16 allows to dynamically indicate the number of repetitions for PUSCH repetition type A by associating the number of repetitions to each row of a time domain resource assignment (TDRA) table. Furthermore, NR

Rel-16 also introduces PUSCH repetition type B for ultra-reliable low latency (URLLC) applications. In PUSCH repetition type B, a single SLIV is used for determining multiple back-to-back nominal repetitions with the same length, and each nominal repetition can span across the slot boundary. Then, each nominal repetition is split into multiple actual repetitions, if it crosses the slots boundary or invalid symbols. The PUSCH repetitions in PUSCH repetition type B also have the same number of allocated resource blocks in frequency domain.

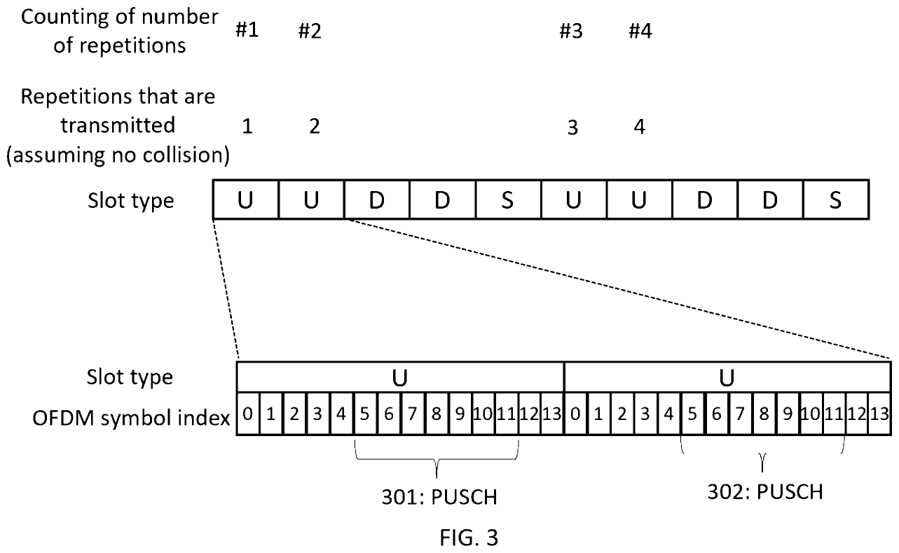

NR Rel-17 further improves PUSCH repetition type A by allowing the number of repetitions to be counted on available slots, i.e., on the slots that are available for the transmissions of the repetitions, as illustrated in FIG. 3. NR Rel-17 also increases the maximum number of repetitions from 16 to 32 for PUSCH repetition type A.

FIG. 3 illustrates an example of PUSCH repetition type A in NR Rel-17 with 4 repetitions, wherein the PUSCH repetitions 301, 302 in a given slot start from symbol number 5 and the length of a given PUSCH repetition 301, 302 is 7 symbols, assuming a DDSUU (10D: 2G: 2U) TDD pattern. In FIG. 3, “D” denotes a downlink slot, “S” denotes a special slot, and “U” denotes an uplink slot.

NR Rel-17 coverage enhancement work item specifies a feature called transport block processing over multiple slots (TBoMS). This feature allows mapping a single transport block (TB) over multiple slots, i.e., resource allocation for a single PUSCH transmission can span across multiple slots. This is different from PUSCH repetitions.

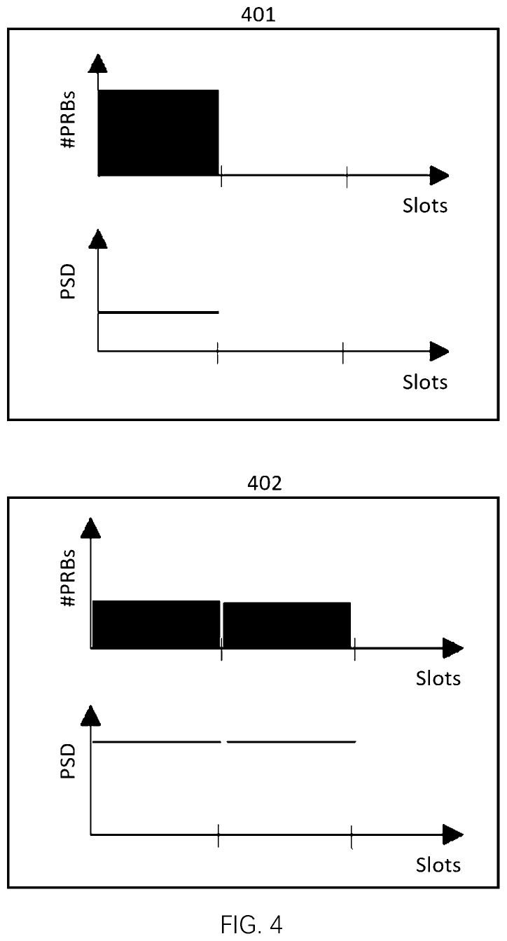

FIG. 4 illustrates an example of the power spectral density (PSD) gain offered by TBoMS, as shown in 402, compared to single-slot PUSCH, as shown in 401, for the same transport block size.

As illustrated in FIG. 4, one main advantage of TBoMS is that it can reduce the number of physical resource blocks (PRBs) needed for transmitting the same transport block size (TBS) compared to the case when the TB is transmitted in a single slot. This helps to increase the energy per resource element (EPRE), therefore improving the coverage.

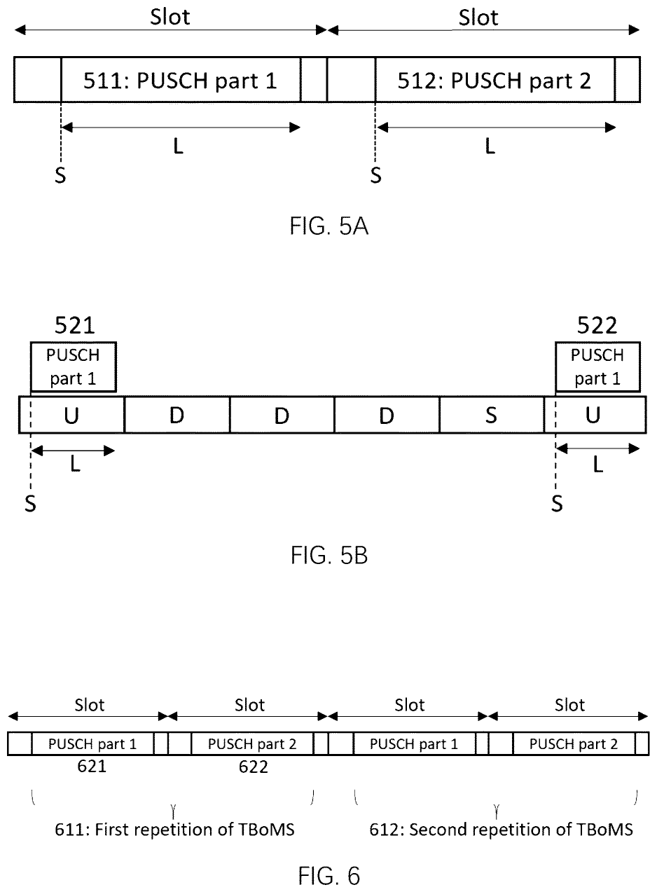

A new column may be added in the TDRA table for indicating the number of slots (Nₛₗₒₜ) allocated for TBoMS. Nₛₗₒₜ may be counted on available slots. Hence, non-consecutive slots can be used for TBoMS in TDD. The same starting symbol(S) and length (L) for the resource in each slot may be allocated for TBoMS (similar to PUSCH repetition type A), as shown in FIG. 5A and FIG. 5B.

FIG. 5A illustrates an example of consecutive slot allocation for TBoMS with Nₛₗₒₜ=2. Two parts 511, 512 of resource are allocated for a single TBoMS.

FIG. 5B illustrates an example of non-consecutive slot allocation for TBoMS with Nₛₗₒₜ=2. Two parts 521, 522 of resource are allocated for a single TBoMS. In FIG. 5B, “D” denotes a downlink slot, “S” denotes a special slot, and “U” denotes an uplink slot.

Repetitions of a single TBoMS may be supported. The column in the TDRA table that indicates the number of repetitions for Rel-17 PUSCH repetition type A (i.e., numberOfRepetitions-r17) may be used also for indicating the number of repetitions (Nᵣₑₚ) of a single TBoMS. The UE may determine Nᵣₑₚ*Nₛₗₒₜ available slots for TBoMS repetition, the same starting symbol(S) and length (L) on each slot, but TBS may be calculated by the resource of a single TBoMS (i.e., scaled by Nₛₗₒₜ). Redundancy versions (RVs) may be cycled across the TBoMS repetitions. The legacy Rel-15 or Rel-16 RV sequences and RV index indication may be reused.

FIG. 6 illustrates an example of TBoMS repetitions 611, 612 with Nₛₗₒₜ=2 and Nᵣₑₚ=2. Two parts 621, 622 of resource are allocated for a single TBoMS repetition 611.

An uplink control information (UCI) message may comprise at least one of the following information: hybrid automatic repeat request acknowledgement (HARQ-ACK), channel state information (CSI), and/or scheduling request (SR). CSI may comprise CSI part 1 and CSI part 2, wherein CSI part 1 has a fixed payload size and is used to identify the number of information bits in CSI part 2. Therefore, CSI part 1 should be transmitted completely before the transmission of CSI part 2.

The UCI message may be encoded and transmitted through physical uplink control channel (PUCCH) or multiplexed on PUSCH. At least HARQ-ACK and CSI may be multiplexed on PUSCH. SR may not need to be multiplexed on PUSCH, since PUSCH is able to convey a buffer status report (BSR), which contains more detailed information about the UE's uplink buffer status than SR.

A higher-layer parameter known as β parameter (or beta offset) may be used by the UE to determine the amount of resources within PUSCH to be dedicated for the UCI in case of multiplexing. This parameter may be different for different UCI types and its payload sizes.

For HARQ-ACK, if the payload is 1 or 2 bits, the resource elements that are originally scheduled for data in PUSCH may be punctured for HARQ-ACK, and β may be configured via betaOffsetACK-Index1. If the payload is from 3 to 11 bits, HARQ-ACK may be rate-matched around the resource elements scheduled for data in PUSCH, and β may be configured via betaOffsetACK-Index2. If the payload is greater than 11 bits, HARQ-ACK may be rate-matched around the resource elements scheduled for data in PUSCH, and β may be configured via betaOffsetACK-Index3.

For CSI part 1, if the payload is up to 11 bits, CSI part 1 may be rate-matched around the resource elements scheduled for data in PUSCH, and β may be configured via betaOffsetCSI-Part1-Index1. If the payload is greater than 11 bits, CSI part 1 may be rate-matched around the resource elements scheduled for data in PUSCH, and β may be configured via betaOffsetCSI-Part1-Index2.

For CSI part 2, if the payload is up to 11 bits, CSI part 2 may be rate-matched around the resource elements scheduled for data in PUSCH, and β may be configured via betaOffsetCSI-Part2-Index1. If the payload is greater than 11 bits, CSI part 2 may be rate-matched around the resource elements scheduled for data in PUSCH, and β may be configured via betaOffsetCSI-Part2-Index2.

UCI mapping follows a frequency-first time-second principle, starting from the lowest resource element of the smallest symbol index. In a nutshell, UCI mapping (i.e., multiplexing UCI on PUSCH) may comprise the following six steps.

In the first step, when the number of HARQ-ACK bits is less than or equal to 2, find the reserved HARQ-ACK locations.

In the second step, when the number of HARQ-ACK bits is greater than 2, map the coded HARQ-ACK bits (if any).

In the third step, map the coded CSI part 1 and CSI part 2 bits (if any).

In the fourth step, map the coded uplink shared channel (UL-SCH) bits (if any).

In the fifth step, when the number of HARQ-ACK bits is less than or equal to 2, map the coded HARQ-ACK bits (if any).

In the sixth step, form the codeword.

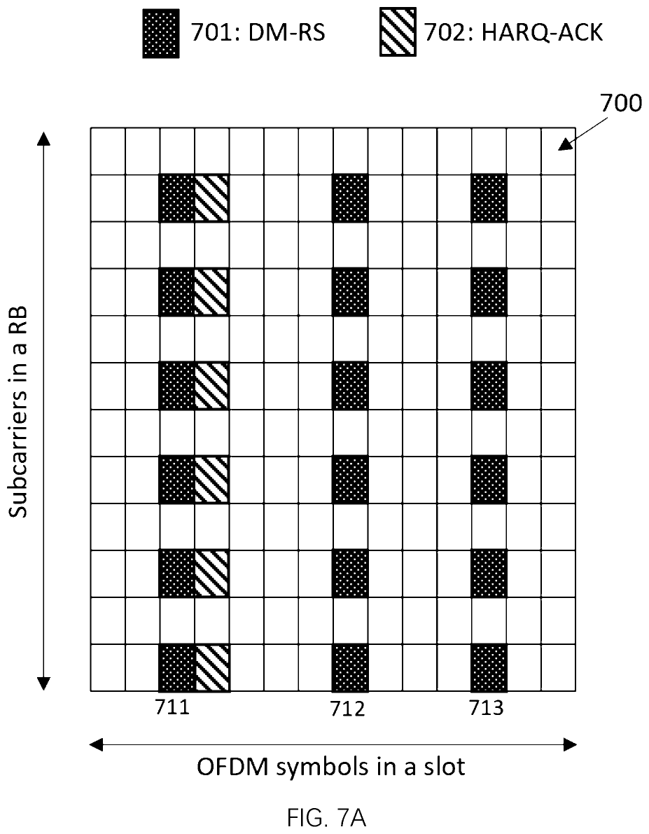

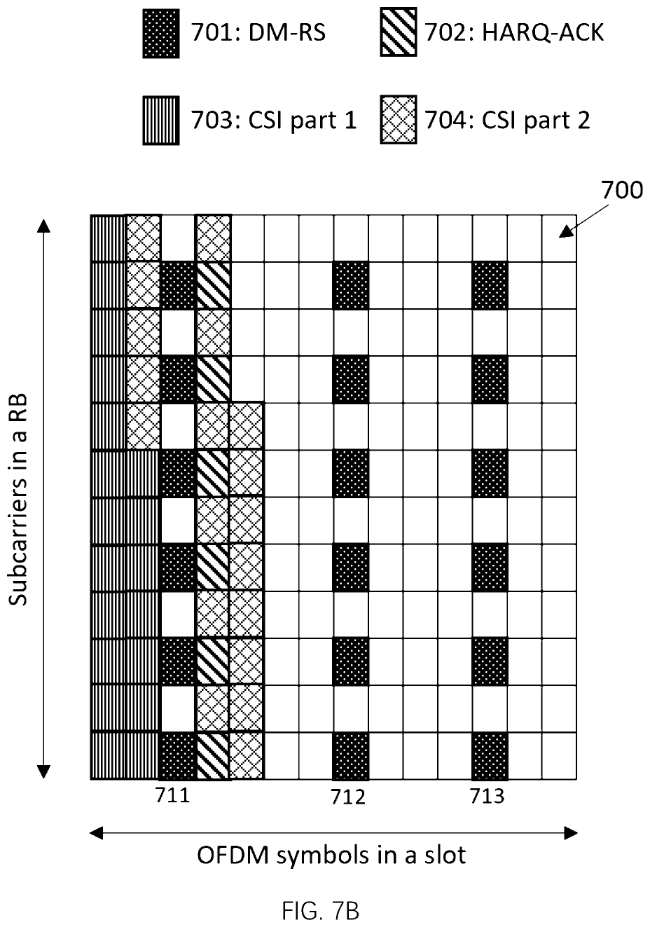

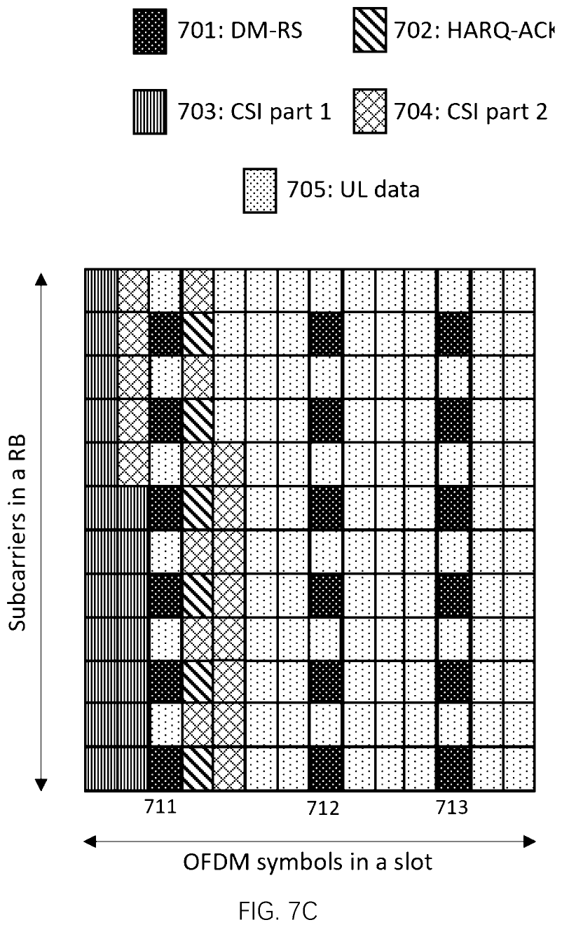

FIG. 7A illustrates an example of mapping HARQ-ACK on PUSCH (corresponding to the second step described above).

FIG. 7B illustrates an example of mapping CSI on PUSCH (corresponding to the third step described above).

FIG. 7C illustrates an example of mapping UL data on PUSCH (corresponding to the fourth step described above).

A given element 700 in FIGS. 7A, 7B and 7C represents one resource element (RE). The example of FIGS. 7A, 7B and 7C considers 1 resource block, single layer, pi/2-BPSK modulation scheme (thus 1 RE corresponds to 1 bit for illustration purpose), and demodulation reference signal (DM-RS) symbols 711, 712, 713 are located on OFDM symbol number 2, 7, and 11 (symbol index starts from 0). BPSK is an abbreviation for binary phase shift keying. The REs other than DM-RS REs 701 in the DM-RS symbols 711, 712, 713 are used for data transmission (comb type). This example assumes 6 HARQ-ACK bits 702, 19 CSI part 1 bits 703, 19 CSI part 2 bits 704, and 106 bits for data. The UCI mapping following the above six steps in this example is as follows.

In the first step, since the number of HARQ-ACK bits in this example is 6 (>2), this step of finding the reserved REs is skipped.

In the second step, the coded HARQ-ACK bits 702 are mapped as shown in FIG. 7A. The HARQ-ACK is mapped to the REs in the OFDM symbol that is available after the first DM-RS OFDM symbol 711. In this example, the number of REs required for HARQ-ACK is 6. Because this value is not greater than half of the number of REs available for UCI transmission, the mapping of the HARQ-ACK is distributed as shown in FIG. 7A.

In the third step, the coded CSI part 1 bits 703 and the coded CSI part 2 bits 704 are mapped as shown in FIG. 7B. The CSI mapping starts from the first non-DMRS OFDM symbol available in the PUSCH allocation. In this example, the CSI mapping starts from OFDM symbol 0. The mapping locations are determined based on the number of REs available, and the number of REs required for CSI part 1 transmission. In this example, CSI part 1 transmission requires 19 REs. Because only 12 REs are available for transmission in a given symbol, every RE in OFDM symbol 0 is occupied in this case for CSI part 1. For the transmission of the remaining CSI part 1 bits, the mapping goes to the next OFDM symbol not used for DM-RS (i.e., OFDM symbol 1 in this example). In OFDM symbol 1, 12 REs are available, but CSI part 1 requires only 7 REs more.

In the fourth step, the coded UL data bits 705 are mapped to the remaining REs, as shown in FIG. 7C.

In the fifth step, since the number of HARQ-ACK bits in this example is 6 (>2), this step of mapping the coded HARQ-ACK bits is skipped.

In the sixth step, the codeword is formed.

From the above, it can be observed that UCI is mostly multiplexed on the first few symbols of the PUSCH in a slot.

In the following, UCI multiplexing in case PUSCH is transmitted with repetitions is discussed. If a UE transmits a PUSCH over multiple slots, or multiple PUSCHs over multiple slots that are scheduled by a DCI (e.g., with DCI format 0_1 or format 0_2), and the UE would transmit a PUCCH with HARQ-ACK and/or CSI information over a single slot that overlaps with the PUSCH transmission in one or more slots of the multiple slots, and the PUSCH transmission in the one or more slots fulfils certain conditions for multiplexing the HARQ-ACK and/or CSI information, the UE multiplexes the HARQ-ACK and/or CSI information in the PUSCH transmission in the one or more slots.

From the above, it can be observed that, in case of multiplexing due to overlapping with PUCCH, the UCI is multiplexed on the overlapping slot(s).

However, there is a special case when aperiodic CSI (A-CSI) is requested and conveyed on PUSCH (A-CSI on PUSCH). In this case, the following may be applied.

For PUSCH repetition type B, when a UE is scheduled to transmit a transport block and aperiodic CSI report(s) on PUSCH by a ‘CSI request’ field on a downlink control information (DCI), the CSI report(s) may be multiplexed only on the first actual repetition. The UE does not expect that the first actual repetition has a single symbol duration.

For PUSCH repetition type A, when a DCI format 0_1 and DCI format 0_2 indicate codepoint “10” or “11” for the sounding reference signal (SRS) resource set indicator and schedule aperiodic CSI report(s) on PUSCH with transport block by a ‘CSI request’ field on a DCI, the CSI report(s) multiplexing may be determined as follows.

If higher layer parameter AP-CSI-MultiplexingMode in CSI-AssociatedReportConfigInfo is enabled and UCI other than CSI report(s) are not multiplexed on PUSCH, the CSI report(s) may be transmitted separately only on the first transmission occasion associated with the first SRS resource set and the first transmission occasion associated with the second SRS resource set.

Otherwise, the CSI report(s) may be transmitted only on the first transmission occasion.

For PUSCH transmissions of TB processing over multiple slots, when a DCI format 0_1 and DCI format 0_2 schedule aperiodic CSI report(s) on PUSCH with transport block by a ‘CSI request’ field on a DCI, the CSI report(s) may be transmitted only on the first slot of the N·K slots determined for the PUSCH transmission.

From the above, it can be observed that A-CSI may be only multiplexed on the first PUSCH repetition or transmission for either PUSCH repetition type A, type B or TBoMS.

5G NR currently supports two duplexing modes: frequency-division duplexing (FDD) for paired bands, and time-division duplexing (TDD) for unpaired bands. In TDD, the time domain resource is split between downlink and uplink. Allocation of a limited time duration for the uplink in TDD would result in reduced coverage, increased latency, and reduced capacity.

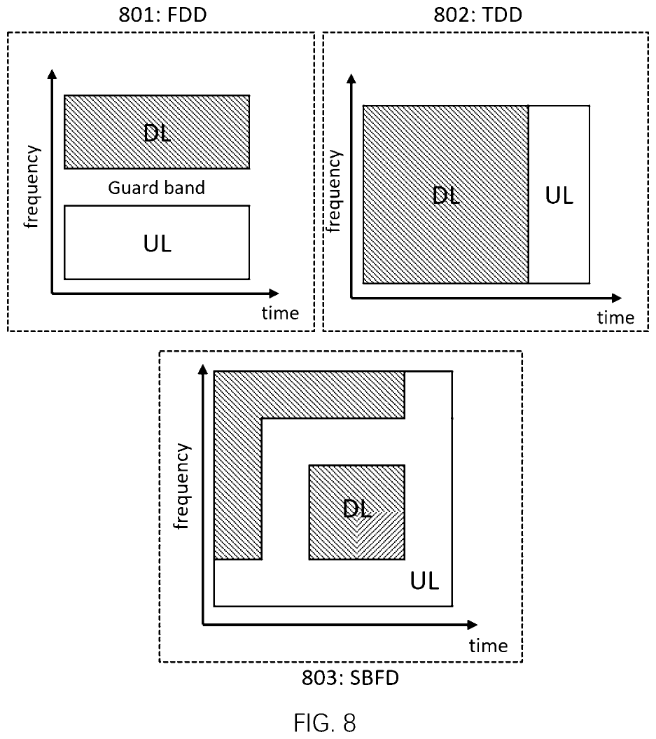

Motivated by this, 3GPP has agreed to initiate a Rel-18 study item (RP-213591) on the evolution of duplexing operation in NR that addresses the challenges above. One of the objectives of the study item is to allow simultaneous DL and UL transmission on different physical resource blocks (PRBs) or subbands within an unpaired wideband NR cell, as illustrated in FIG. 8. Herein this duplexing scheme is referred to as subband full duplex (SBFD) or subband non-overlapping full duplex. SBFD may also be referred to as cross division duplexing (xDD) or flexible division duplexing (FDU).

FIG. 8 illustrates an example of frequency-time resource partitioning with SBFD 803 as compared to FDD 801 and TDD 802.

Some of the objectives of the study item include studying the subband non-overlapping full duplex, identifying possible schemes and evaluating their feasibility and performances, as well as to study inter-gNB inter-UE cross link interference (CLI) handling and to identify solutions to manage them by considering intra-subband CLI and inter-subband CLI in case of the subband non-overlapping full duplex.

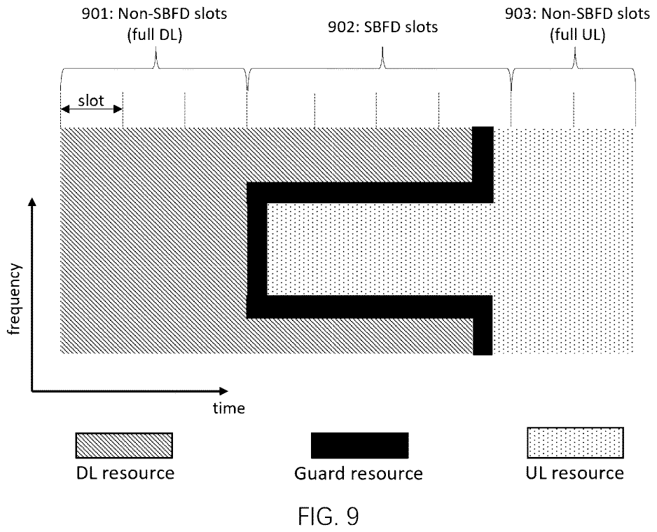

From the above description of SBFD operation, it can be observed that there are two slot types for both DL and UL transmissions (as shown in FIG. 9), namely: 1) SBFD slots, during which the non-overlapping DL subbands and UL subband(s) both exist; and 2) non-SBFD slots, during which the entire band is used for either DL or UL (i.e., legacy/full DL/UL slots).

Several SBFD operation modes have been studied, including whether time and frequency locations of subbands for SBFD operation are known to the SBFD-aware UE or not. However, it has been agreed that at least the operation mode with time and frequency locations of subbands for SBFD operation being known to the SBFD-aware UE is prioritized. This means that SBFD slots should be known by the (SBFD-aware) UE in one way or another.

FIG. 9 illustrates an example of SBFD slots 902 and non-SBFD slots 901, 903.

SBFD introduces a new CLI type, namely co-channel inter-subband CLI. This interference can be classified as: 1) gNB self-interference, 2) intra-cell UE-to-UE co-channel inter-subband CLI, 3) inter-cell UE-to-UE co-channel inter-subband CLI, and 4) gNB-to-gNB co-channel inter-subband CLI.

Besides these new CLI types, in case of different frequency domain partitioning in neighbor cells, the system may also suffer from co-channel intra-subband CLI, i.e., CLI from transmissions on overlapping frequency resources: 5) gNB-to-gNB inter-cell co-channel intra-subband CLI, and 6) UE-to-UE inter-cell co-channel intra-subband CLI.

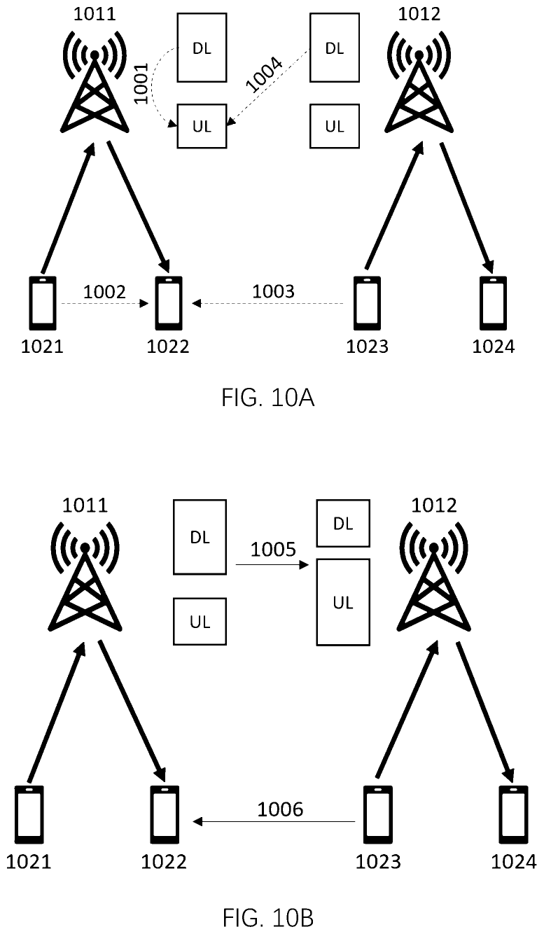

FIG. 10A illustrates examples of co-channel interference types in an SBFD deployment with same frequency domain partitioning. FIG. 10A illustrates a system comprising two gNBs 1011, 1012, and four UEs 1021, 1022, 1023, 1024.

Referring to FIG. 10A, 1001 illustrates gNB self-interference, 1002 illustrates intra-cell UE-to-UE co-channel inter-subband CLI, 1003 illustrates inter-cell UE-to-UE co-channel inter-subband CLI, and 1004 illustrates gNB-to-gNB co-channel inter-subband CLI.

FIG. 10B illustrates examples of co-channel interference types in an SBFD deployment with different frequency domain partitioning. FIG. 10B illustrates a system comprising two gNBs 1011, 1012, and four UEs 1021, 1022, 1023, 1024.

Referring to FIG. 10B, 1005 illustrates gNB-to-gNB inter-cell co-channel intra-subband CLI, and 1006 illustrates UE-to-UE inter-cell co-channel intra-subband CLI.

There is an issue related to non-uniform distribution of CLI level in the resource blocks (RBs) allocated for UL transmission in UL subband. It can be observed from FIGS. 10A and 10B that UL transmission in a SBFD slot or symbol suffers from not only co-channel intra-subband CLI, but also from inter-subband CLI. The inter-subband CLI level is non-uniform across the RBs allocated for UL transmission in UL subband. Indeed, those RBs that are close to the DL subband(s) will be suffering from inter-subband CLI more than those RBs that are further away from the DL subband(s). Therefore, it is beneficial to avoid mapping UCI on those RBs that are close to the DL subband(s) to better protect the UCI. However, currently, there is no solution available for avoiding mapping UCI on the RBs that are close to DL subband(s).

Some example embodiments may address the above issue by providing a method for mapping coded UCI bits on an uplink transmission in SBFD operation. Some example embodiments described below may help to protect UCI from CLI, in case the UCI is multiplexed on an uplink transmission for SBFD operation.

Some example embodiments are described below using principles and terminology of 5G radio access technology without limiting the example embodiments to 5G radio access technology, however.

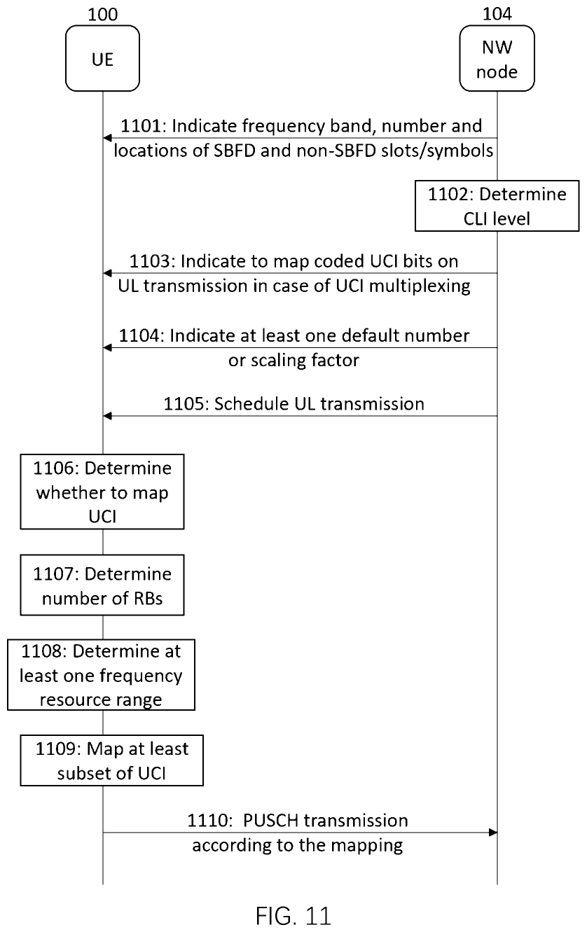

FIG. 11 illustrates a signal flow diagram according to an example embodiment. This example embodiment aims at avoiding UCI to be mapped to the resource blocks that are close to the DL subband(s), which have more inter-subband interference. This example embodiment may be applicable to any uplink transmission (e.g., PUSCH) in SBFD slot and does not require the transmission to span across different symbol types.

Referring to FIG. 11, at 1101 a network node (NW node) 104 transmits, to a UE 100, information comprising at least the following: a frequency band; a number of SBFD slots and/or symbols (i.e., wherein the frequency band is split into multiple subbands, and wherein at least one subband is used for DL transmissions and at least one subband is used for UL transmissions), and locations of the number of SBFD slots and/or symbols in a radio frame; a number of non-SBFD slots and/or symbols (i.e., wherein the entire frequency band is used for DL transmissions or UL transmissions), and locations of the number of non-SBFD slots and/or symbols in a radio frame; and a number and location of gap symbols(s) in a special slot, if any.

The UE is configured with one or more slots in SBFD operation by receiving the information. The network node may be, for example, a radio access network node such as a gNB.

At 1102, the network node may determine a cross link interference level associated with a physical uplink shared channel from the UE. The cross link interference (CLI) level may be measured by the network node and/or reported by the UE. If the CLI level is reported by the UE, the network node may determine the CLI level based on at least one of the reports from the UE and measured by the network node itself.

At 1103, the network node transmits, to the UE, an indication indicating to map uplink control information on the physical uplink shared channel at one or more slots, wherein the one or more slots are configured for subband full duplex (SBFD) operation, in case uplink control information is to be multiplexed on the PUSCH. For example, the indication may be transmitted via RRC. The UE receives the indication.

The network node may determine to transmit the indication based on the cross link interference level being above a threshold. Otherwise, legacy mapping may be applied (e.g., as shown in FIGS. 7A, 7B, and 7C).

It should be noted that 1103 may alternatively be performed before 1101, or 1101 and 1103 may be merged into a single step.

At 1104, the network node transmits, to the UE, an indication indicating at least one default number of resource blocks (Δ_{RB,default}) or at least one scaling factor for determining a number of resource blocks in allocated resource blocks of the physical uplink shared channel that are within a pre-defined distance from one or more downlink subbands or one or more guard bands in frequency domain.

The indication of 1104 may be transmitted together with the indication of 1103 via high layer signal (e.g., RRC or MAC layer signalling) or physical layer signal, or the indications may be transmitted separately.

At 1105, the network node schedules, for example via scheduling DCI, the PUSCH in one or more slots that comprises SBFD symbols, or both SBFD symbols and non-SBFD symbols, which may lead to UCI multiplexing on the PUSCH in case of collision. For example, in case the PUSCH is overlapped in time with a physical uplink control channel (PUCCH) that conveys a UCI, the UCI may be multiplexed on the PUSCH and the PUCCH is dropped. Alternatively, or additionally, the network node may schedule PUSCH with repetitions or TBoMS that spans across SBFD slots and non-SBFD slots.

As an alternative to 1103 and 1104, the network node may transmit the indications of 1103 and 1104 to the UE via the scheduling DCI at 1105. As described above, the indication may depend on the CLI level that is measured by the network node and/or reported by the UE. For example, in case the CLI is above a threshold (i.e., in case of high CLI), then the mapping may be applied. Otherwise, legacy mapping may be applied (e.g., as shown in FIGS. 7A, 7B, and 7C).

At 1106, the UE determines, based at least on the indication of 1103, whether to map the uplink control information on the PUSCH in the SBFD operation.

For example, the UE may determine whether UCI should be multiplexed on PUSCH in case of collision. The UE may also determine the SBFD slot(s), special slot(s), and non-SBFD slot(s), and/or the SBFD symbols, gap symbols, and non-SBFD symbols in a given slot.

The one or more gap symbols are a gap for UE to switch from downlink reception to uplink transmission in case the UE receives a downlink transmission in the at least one downlink subband. In other words, the one or more gap symbols refer to symbols reserved as a guard period between downlink and uplink transmissions in the same or different subbands of the same frequency band.

The uplink control information may comprise at least one of: HARQ-ACK information, CSI part 1, and/or CSI part 2.

At 1107, the UE determines, based on the at least one default number of resource blocks (Δ_{RB,default}) or the at least one scaling factor, a number of resource blocks (Δ_{RB}) in allocated resource blocks of the physical uplink shared channel that are within a pre-defined distance from one or more downlink subbands or one or more guard bands in frequency domain. In other words, the UE determines a number of RBs (Δ_{RB}) that are close to DL subband(s) or guard band(s) in frequency domain.

For example, the UE may decide to determine Δ_{RB}, if the PUSCH is allocated on one or more specific sets of RBs within the UL subband (e.g., those RBs that are close to the DL subband(s)). In other words, the UE may determine whether the physical uplink shared channel is allocated on one or more pre-defined sets of resource blocks within the uplink sub-band, and the number of resource blocks may be determined based on determining that the physical uplink shared channel is allocated on at least one of the one or more pre-defined sets of resource blocks within the uplink sub-band. As shown in the example of FIG. 15, the one or more pre-defined sets of resource blocks may comprise multiple sets of resource blocks 1501, 1502, 1503, 1504, 1505, 1506, 1507 that are overlapping at least partially. For example, if the PUSCH spans across two RB sets 1504, 1505, it may be considered to be scheduled in the superset 1502 of the two sets 1504, 1505.

Alternatively, the UE may determine whether a distance in resource blocks between the one or more downlink subbands and at least one of: a resource block with a highest resource block index and/or a resource block with a lowest resource block index among resource blocks allocated for the physical uplink shared channel, is lower than a threshold. In this case, the number of resource blocks may be determined based on determining that the distance is lower than the threshold.

In one example, the number of resource blocks may be determined based on the at least one default number of resource blocks, the allocated resource blocks of the physical uplink shared channel, and a bandwidth of an uplink subband where the physical uplink shared channel is allocated. In this case, the at least one default number of resource blocks may comprise one default number of resource blocks. For example, if a unique (i.e., single) default number (Δ_{RB,default}) is indicated from the network node (e.g., via RRC), the UE may determine the number of resource blocks Δ_{RB} by:

$${Δ}_{RB} = {Δ}_{RB , default} \times ( \frac{allocated RBs for PUSCH}{UL subband bandwidth} )$$

In another example, the at least one default number of resource blocks may comprise multiple different default numbers for different sets of resource blocks in an uplink subband. In this case, the UE may determine (or select) a default number of resource blocks Δ_{RB, default} from the multiple different default numbers based on the allocated resource blocks of the physical uplink shared channel in the uplink subband (i.e., based on the RB set in the UL subband where the PUSCH is allocated). In this case, the number of resource blocks may be determined based on the default number of resource blocks, the allocated resource blocks of the physical uplink shared channel, and a bandwidth of the uplink subband. For example, the UE may determine the number of resource blocks Δ_{RB} by:

$${Δ}_{RB} = {Δ}_{RB , default} \times ( \frac{allocated RBs for PUSCH}{UL subband bandwidth} )$$

In another example, the number of resource blocks may be determined by multiplying a number of the allocated resource blocks of the physical uplink shared channel with the at least one scaling factor. In this case, the at least one scaling factor may comprise one scaling factor (i.e., unique scaling factor). For example, the UE may determine the number of resource blocks Δ_{RB} by:

$${Δ}_{RB} = allocated RBs for PUSCH \times scaling factor$$

In another example, the at least one scaling factor may comprise multiple different scaling factors for different sets of resource blocks in an uplink subband. In this case, the UE may determine (or select) a scaling factor from the multiple different scaling factors based on the allocated resource blocks of the physical uplink shared channel in the uplink sub-band (i.e., based on the RB set in the UL subband where the PUSCH is allocated). In this case, the number of resource blocks may be determined by multiplying a number of the allocated resource blocks of the physical uplink shared channel with the scaling factor. For example, the UE may determine the number of resource blocks Δ_{RB} by:

$${Δ}_{RB} = allocated RBs for PUSCH \times scaling factor$$

At 1108, the UE determines, based on the determined number of resource blocks Δ_{RB}, at least one frequency resource range, where at least a subset of the uplink control information should not be mapped, in the allocated frequency resources of the PUSCH.

In one example, the at least one frequency resource range may comprise one frequency resource range corresponding to a bottom resource block or a top resource block of the allocated resource blocks of the physical uplink shared channel in frequency domain.

In another example, the at least one frequency resource range may comprise two frequency resource ranges. One frequency resource range of the two frequency resource ranges may correspond to a bottom resource block of the allocated resource blocks of the physical uplink shared channel in frequency domain. Another frequency resource range of the two frequency resource ranges may correspond to a top resource block of the allocated resource blocks of the physical uplink shared channel in frequency domain.

In other words, the UE may determine the at least one frequency resource range by taking Δ_{RB} from the top RB and/or bottom RB of the allocated RBs for the PUSCH, depending on the RB set where the PUSCH is allocated.

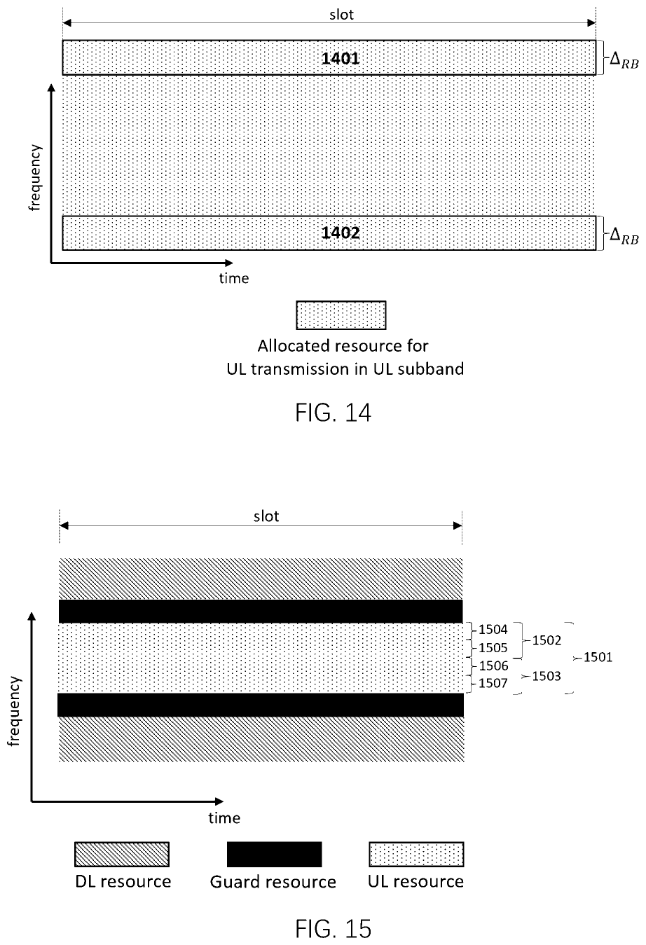

An example of the RB sets 1501, 1502, 1503, 1504, 1505, 1506, 1507 is illustrated in FIG. 15. For example, if the UE determines that the PUSCH is allocated in RB set 1501 of FIG. 15 (i.e., the PUSCH is allocated with almost all UL subband bandwidth), then two frequency resource ranges 1401, 1402 on top and bottom may be determined, as shown in FIG. 14.

As another example, if the UE determines that the PUSCH is allocated in RB sets 1502, 1504 or 1505, then only one frequency resource range 1401 on top may be determined (see FIG. 14).

As another example, if the UE determines that the PUSCH is allocated in RB sets 1503, 1506 or 1507 of FIG. 15, then only one frequency resource range 1402 at bottom may be determined (see FIG. 14).

At 1109, the UE maps the at least subset of the uplink control information on the physical uplink shared channel such that the at least subset of the uplink control information is not mapped to the at least one frequency resource range. Herein the mapping of the uplink control information may mean that the UE maps coded uplink control information bits on the PUSCH.

In one example, the UE may map low-priority uplink control information on the at least one frequency resource range. For example, the low-priority uplink control information may comprise channel state information part 2. In this case, the at least subset of the uplink control information that is not mapped to the at least one frequency resource range may comprise higher-priority uplink control information, such as at least one of: HARQ-ACK information and/or channel state information part 1.

In other words, the UE may map none of the UCI on the determined at least one frequency resource range, or the UE may map only low-priority UCI (e.g., CSI part 2) on the determined at least one frequency resource range.

At 1110, the UE transmits the PUSCH to the network node at the one or more slots according to the outcome of the mapping based on the SBFD operation. The network node receives the PUSCH.

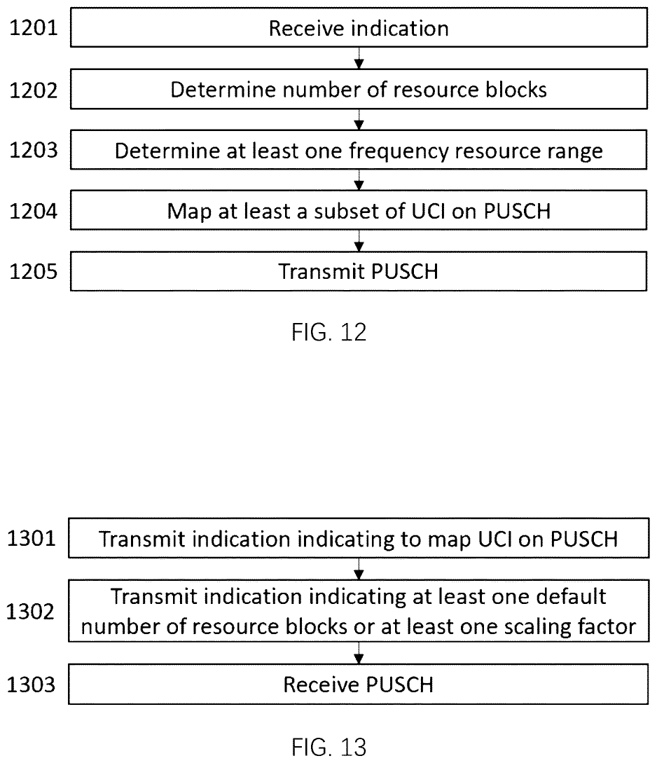

FIG. 12 illustrates a flow chart according to an example embodiment of a method performed by an apparatus 1600. For example, the apparatus 1600 may be, or comprise, or be comprised in, a user device. The user device may also be called a wireless communication device, a subscriber unit, a mobile station, a remote terminal, an access terminal, a user terminal, a terminal device, or user equipment (UE). The user device may correspond to one of the UEs 100, 102 of FIG. 1, or the UE of FIG. 11.

Referring to FIG. 12, in block 1201, the apparatus receives an indication indicating to map uplink control information on a physical uplink shared channel at one or more slots, wherein the one or more slots are configured for a sub-band full duplex, SBFD, operation. The indication may be received from a network node 104.

In block 1202, the apparatus determines, based on at least one default number of resource blocks or at least one scaling factor, a number of resource blocks in allocated resource blocks of the physical uplink shared channel that are within a pre-defined distance from one or more downlink subbands or one or more guard bands in frequency domain.

The at least one default number or the at least one scaling factor may be indicated from the network node, or they may be pre-defined (e.g., hardcoded in the standard).

In block 1203, the apparatus determines, based on the number of resource blocks, at least one frequency resource range where at least a subset of the uplink control information should not be mapped.

In block 1204, the apparatus maps the at least subset of the uplink control information on the physical uplink shared channel such that the at least subset of the uplink control information is not mapped to the at least one frequency resource range.

In block 1205, the apparatus transmits the physical uplink shared channel according to the mapping at the one or more slots. The PUSCH may be transmitted to the network node.

In one example, the number of resource blocks may be determined based on the at least one default number of resource blocks, the allocated resource blocks of the physical uplink shared channel, and a bandwidth of an uplink sub-band where the physical uplink shared channel is allocated, wherein the at least one default number of resource blocks may comprise one default number of resource blocks.

In another example, the at least one default number of resource blocks may comprise multiple different default numbers for different sets of resource blocks in an uplink subband. In this case, the apparatus may determine a default number of resource blocks from the multiple different default numbers based on the allocated resource blocks of the physical uplink shared channel in the uplink sub-band. The number of resource blocks may be determined based on the default number of resource blocks, the allocated resource blocks of the physical uplink shared channel, and a bandwidth of the uplink sub-band.

In another example, the number of resource blocks may be determined by multiplying a number of the allocated resource blocks of the physical uplink shared channel with the at least one scaling factor, wherein the at least one scaling factor may comprise one scaling factor.

In another example, the at least one scaling factor may comprise multiple different scaling factors for different sets of resource blocks in an uplink sub-band. In this case, the apparatus may determine a scaling factor from the multiple different scaling factors based on the allocated resource blocks of the physical uplink shared channel in the uplink sub-band. The number of resource blocks may be determined by multiplying a number of the allocated resource blocks of the physical uplink shared channel with the scaling factor.

The apparatus may determine whether the physical uplink shared channel is allocated on one or more pre-defined sets of resource blocks within the uplink sub-band. The number of resource blocks may be determined based on determining that the physical uplink shared channel is allocated on at least one of the one or more pre-defined sets of resource blocks within the uplink sub-band. For example, the one or more pre-defined sets of resource blocks comprise multiple sets of resource blocks that are overlapping at least partially.

Alternatively, the apparatus may determine whether a distance in resource blocks between the one or more downlink subbands and at least one of: a resource block with a highest resource block index or a resource block with a lowest resource block index among resource blocks allocated for the physical uplink shared channel, is lower than a threshold. The number of resource blocks may be determined based on determining that the distance is lower than the threshold.

In one example, the at least one frequency resource range may comprise one frequency resource range corresponding to a bottom resource block or a top resource block of the allocated resource blocks of the physical uplink shared channel in frequency domain.

In another example, the at least one frequency resource range may comprise two frequency resource ranges, wherein one frequency resource range of the two frequency resource ranges corresponds to a bottom resource block of the allocated resource blocks of the physical uplink shared channel in frequency domain, and wherein another frequency resource range of the two frequency resource ranges corresponds to a top resource block of the allocated resource blocks of the physical uplink shared channel in frequency domain.

In one example, the apparatus may map low-priority uplink control information on the at least one frequency resource range. For example, the low-priority uplink control information may comprise channel state information part 2.

FIG. 13 illustrates a flow chart according to an example embodiment of a method performed by an apparatus 1700. For example, the apparatus 1700 may be, or comprise, or be comprised in, a network node of a radio access network. The network node may correspond to the access node 104 of FIG. 1, or the network node of FIG. 11.

Referring to FIG. 13, in block 1301, the apparatus transmits, to a user device 100, an indication indicating to map uplink control information on a physical uplink shared channel at one or more slots, wherein the one or more slots are configured for a sub-band full duplex, SBFD, operation.

The apparatus may determine a cross link interference level associated with the physical uplink shared channel. In this case, the apparatus may determine, based on the cross link interference level being above a threshold, to transmit the indication indicating to map the uplink control information on the physical uplink shared channel.

In block 1302, the apparatus transmits, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain.

At 1303, the apparatus receives, from the user device, the physical uplink shared, wherein at least a subset of the uplink control information is mapped on the physical uplink shared channel, wherein the at least subset of the uplink control information is not mapped in the number of resource blocks.

In one example, the number of resource blocks may be determined based on the at least one default number of resource blocks, the allocated resource blocks of the physical uplink shared channel, and a bandwidth of an uplink sub-band where the physical uplink shared channel is allocated, wherein the at least one default number of resource blocks may comprise one default number of resource blocks.

In another example, the at least one default number of resource blocks may comprise multiple different default numbers for different sets of resource blocks in an uplink subband. In this case, the user device may determine a default number of resource blocks from the multiple different default numbers based on the allocated resource blocks of the physical uplink shared channel in the uplink sub-band. The number of resource blocks may be determined based on the default number of resource blocks, the allocated resource blocks of the physical uplink shared channel, and a bandwidth of the uplink sub-band.

In another example, the number of resource blocks may be determined by multiplying a number of the allocated resource blocks of the physical uplink shared channel with the at least one scaling factor, wherein the at least one scaling factor may comprise one scaling factor.

In another example, the at least one scaling factor may comprise multiple different scaling factors for different sets of resource blocks in an uplink sub-band. In this case, the user device may determine a scaling factor from the multiple different scaling factors based on the allocated resource blocks of the physical uplink shared channel in the uplink sub-band. The number of resource blocks may be determined by multiplying a number of the allocated resource blocks of the physical uplink shared channel with the scaling factor.

The user device may determine whether the physical uplink shared channel is allocated on one or more pre-defined sets of resource blocks within the uplink sub-band. The number of resource blocks may be determined based on determining that the physical uplink shared channel is allocated on at least one of the one or more pre-defined sets of resource blocks within the uplink sub-band. For example, the one or more pre-defined sets of resource blocks comprise multiple sets of resource blocks that are overlapping at least partially.

Alternatively, the user device may determine whether a distance in resource blocks between the one or more downlink subbands and at least one of: a resource block with a highest resource block index or a resource block with a lowest resource block index among resource blocks allocated for the physical uplink shared channel, is lower than a threshold. The number of resource blocks may be determined based on determining that the distance is lower than the threshold.

The user device may determine, based on the number of resource blocks, at least one frequency resource range where at least the subset of the uplink control information should not be mapped.

In one example, the at least one frequency resource range may comprise one frequency resource range corresponding to a bottom resource block or a top resource block of the allocated resource blocks of the physical uplink shared channel in frequency domain.

In another example, the at least one frequency resource range may comprise two frequency resource ranges, wherein one frequency resource range of the two frequency resource ranges corresponds to a bottom resource block of the allocated resource blocks of the physical uplink shared channel in frequency domain, and wherein another frequency resource range of the two frequency resource ranges corresponds to a top resource block of the allocated resource blocks of the physical uplink shared channel in frequency domain.

In one example, the user device may map low-priority uplink control information on the at least one frequency resource range. For example, the low-priority uplink control information may comprise channel state information part 2.

The blocks, related functions, and information exchanges (messages) described above by means of FIGS. 11-13 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

FIG. 14 illustrates an example of determining the at least one frequency resource range (e.g., in block 1108 of FIG. 11, or in block 1203 of FIG. 12), in which at least a subset of UCI should not be mapped, within the allocated frequency resources for a PUSCH transmission. In this example, the at least subset of UCI is not mapped in the resource blocks in 1401 and 1402, but it may be mapped in the resource blocks between 1401 and 1402.

FIG. 15 illustrates an example of setting different resource block sets 1501, 1502, 1503, 1504, 1505, 1506, 1507 in uplink subband.

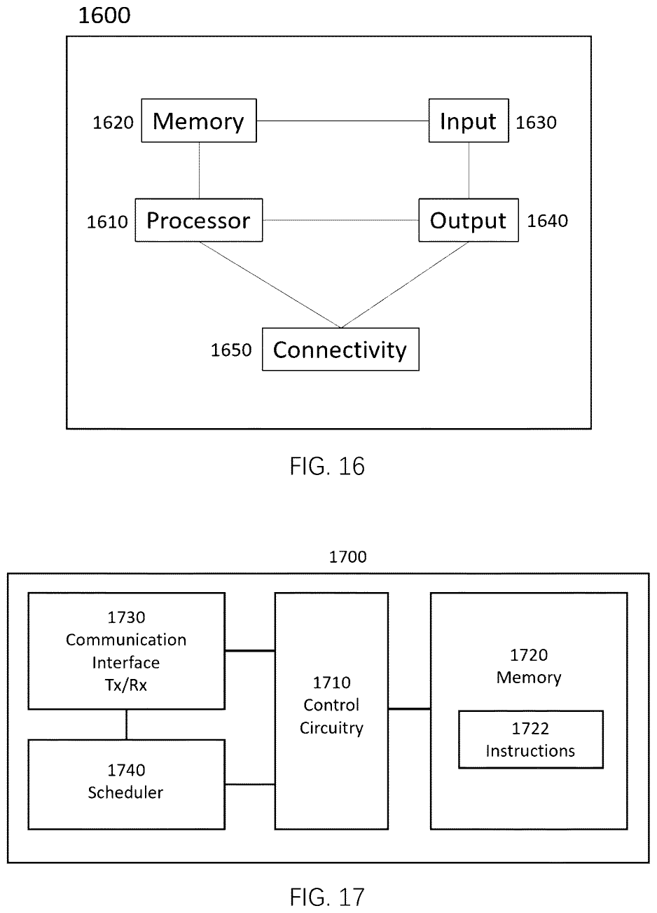

FIG. 16 illustrates an example of an apparatus 1600 comprising means for performing one or more of the example embodiments described above. For example, the apparatus 1600 may be an apparatus such as, or comprising, or comprised in, a. The user device may also be called a wireless communication device, a subscriber unit, a mobile station, a remote terminal, an access terminal, a user terminal, a terminal device, or user equipment (UE). The user device may correspond to one of the UEs 100, 102 of FIG. 1, or the UE of FIG. 11.

The apparatus 1600 may comprise a circuitry or a chipset applicable for realizing one or more of the example embodiments described above. For example, the apparatus 1600 may comprise at least one processor 1610. The at least one processor 1610 interprets instructions (e.g., computer program instructions) and processes data. The at least one processor 1610 may comprise one or more programmable processors. The at least one processor 1610 may comprise programmable hardware with embedded firmware and may, alternatively or additionally, comprise one or more application-specific integrated circuits (ASICs).

The at least one processor 1610 is coupled to at least one memory 1620. The at least one processor is configured to read and write data to and from the at least one memory 1620. The at least one memory 1620 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 1620 stores computer readable instructions that are executed by the at least one processor 1610 to perform one or more of the example embodiments described above. For example, non-volatile memory stores the computer readable instructions, and the at least one processor 1610 executes the instructions using volatile memory for temporary storage of data and/or instructions. The computer readable instructions may refer to computer program code.

The computer readable instructions may have been pre-stored to the at least one memory 1620 or, alternatively or additionally, they may be received, by the apparatus, via an electromagnetic carrier signal and/or may be copied from a physical entity such as a computer program product. Execution of the computer readable instructions by the at least one processor 1610 causes the apparatus 1600 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1600 may further comprise, or be connected to, an input unit 1630. The input unit 1630 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1630 may comprise an interface to which external devices may connect to.

The apparatus 1600 may also comprise an output unit 1640. The output unit may comprise or be connected to one or more displays capable of rendering visual content, such as a light emitting diode (LED) display, a liquid crystal display (LCD) and/or a liquid crystal on silicon (LCoS) display. The output unit 1640 may further comprise one or more audio outputs. The one or more audio outputs may be for example loudspeakers.

The apparatus 1600 further comprises a connectivity unit 1650. The connectivity unit 1650 enables wireless connectivity to one or more external devices. The connectivity unit 1650 comprises at least one transmitter and at least one receiver that may be integrated to the apparatus 1600 or that the apparatus 1600 may be connected to. The at least one transmitter comprises at least one transmission antenna, and the at least one receiver comprises at least one receiving antenna. The connectivity unit 1650 may comprise an integrated circuit or a set of integrated circuits that provide the wireless communication capability for the apparatus 1600. Alternatively, the wireless connectivity may be a hardwired application-specific integrated circuit (ASIC). The connectivity unit 1650 may also provide means for performing at least some of the blocks or functions of one or more example embodiments described above. The connectivity unit 1650 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1600 may further comprise various components not illustrated in FIG. 16. The various components may be hardware components and/or software components.

FIG. 17 illustrates an example of an apparatus 1700 comprising means for performing one or more of the example embodiments described above. For example, the apparatus 1700 may be an apparatus such as, or comprising, or comprised in, a network node of a radio access network. The network node may correspond to the access node 104 of FIG. 1, or the network node of FIG. 11.

The network node may also be referred to, for example, as a network element, a radio access network (RAN) node, a next generation radio access network (NG-RAN) node, a NodeB, an eNB, a gNB, a base transceiver station (BTS), a base station, an NR base station, a 5G base station, an access node, an access point (AP), a cell site, a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1700 may comprise, for example, a circuitry or a chipset applicable for realizing one or more of the example embodiments described above. The apparatus 1700 may be an electronic device comprising one or more electronic circuitries. The apparatus 1700 may comprise a communication control circuitry 1710 such as at least one processor, and at least one memory 1720 storing instructions 1722 which, when executed by the at least one processor, cause the apparatus 1700 to carry out one or more of the example embodiments described above. Such instructions 1722 may, for example, include computer program code (software). The at least one processor and the at least one memory storing the instructions may provide the means for providing or causing the performance of any of the methods and/or blocks described above.

The processor is coupled to the memory 1720. The processor is configured to read and write data to and from the memory 1720. The memory 1720 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1720 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 1720 or, alternatively or additionally, they may be received, by the apparatus, via an electromagnetic carrier signal and/or may be copied from a physical entity such as a computer program product. Execution of the computer readable instructions causes the apparatus 1700 to perform one or more of the functionalities described above.

The memory 1720 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

The apparatus 1700 may further comprise or be connected to a communication interface 1730, such as a radio unit, comprising hardware and/or software for realizing communication connectivity with one or more wireless communication devices according to one or more communication protocols. The communication interface 1730 comprises at least one transmitter (Tx) and at least one receiver (Rx) that may be integrated to the apparatus 1700 or that the apparatus 1700 may be connected to. The communication interface 1730 may provide means for performing some of the blocks for one or more example embodiments described above. The communication interface 1730 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 1730 provides the apparatus with radio communication capabilities to communicate in the wireless communication network. The communication interface may, for example, provide a radio interface to one or more wireless communication devices. The apparatus 1700 may further comprise or be connected to another interface towards a core network such as the network coordinator apparatus or AMF, and/or to the access nodes of the wireless communication network.

The apparatus 1700 may further comprise a scheduler 1740 that is configured to allocate radio resources. The scheduler 1740 may be configured along with the communication control circuitry 1710 or it may be separately configured.

It is to be noted that the apparatus 1700 may further comprise various components not illustrated in FIG. 17. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the embodiments.

1. An apparatus comprising at least one processor, and at least one memory storing instructions that, when executed by the at least one processor, cause the apparatus at least to:
receive an indication indicating to map uplink control information on a physical uplink shared channel at one or more slots, wherein the one or more slots are configured for a sub-band full duplex, SBFD, operation;
determine, based on at least one default number of resource blocks or at least one scaling factor, a number of resource blocks in allocated resource blocks of the physical uplink shared channel that are within a pre-defined distance from one or more downlink subbands or one or more guard bands in frequency domain;
determine, based on the number of resource blocks, at least one frequency resource range where at least a subset of the uplink control information should not be mapped;
map the at least subset of the uplink control information on the physical uplink shared channel such that the at least subset of the uplink control information is not mapped to the at least one frequency resource range; and
transmit the physical uplink shared channel according to the mapping at the one or more slots.

2. The apparatus according to claim 1, wherein the number of resource blocks is determined based on the at least one default number of resource blocks, the allocated resource blocks of the physical uplink shared channel, and a bandwidth of an uplink sub-band where the physical uplink shared channel is allocated,
wherein the at least one default number of resource blocks comprises one default number of resource blocks.

3. The apparatus according to claim 1, wherein the at least one default number of resource blocks comprises multiple different default numbers for different sets of resource blocks in an uplink sub-band,
wherein the apparatus is further caused to:
determine a default number of resource blocks from the multiple different default numbers based on the allocated resource blocks of the physical uplink shared channel in the uplink sub-band,
wherein the number of resource blocks is determined based on the default number of resource blocks, the allocated resource blocks of the physical uplink shared channel, and a bandwidth of the uplink sub-band.

4. The apparatus according to claim 1, wherein the number of resource blocks is determined by multiplying a number of the allocated resource blocks of the physical uplink shared channel with the at least one scaling factor,
wherein the at least one scaling factor comprises one scaling factor.

5. The apparatus according to claim 1, wherein the at least one scaling factor comprises multiple different scaling factors for different sets of resource blocks in an uplink sub-band,
wherein the apparatus is further caused to:
determine a scaling factor from the multiple different scaling factors based on the allocated resource blocks of the physical uplink shared channel in the uplink sub-band,
wherein the number of resource blocks is determined by multiplying a number of the allocated resource blocks of the physical uplink shared channel with the scaling factor.

6. The apparatus according to any of claims 2-4, further being caused to:
determine whether the physical uplink shared channel is allocated on one or more pre-defined sets of resource blocks within the uplink sub-band,
wherein the number of resource blocks is determined based on determining that the physical uplink shared channel is allocated on at least one of the one or more pre-defined sets of resource blocks within the uplink sub-band.

7. The apparatus according to claim 6, wherein the one or more pre-defined sets of resource blocks comprise multiple sets of resource blocks that are overlapping at least partially.

8. The apparatus according to any of claims 2-4, further being caused to:
determine whether a distance in resource blocks between the one or more downlink subbands and at least one of: a resource block with a highest resource block index or a resource block with a lowest resource block index among resource blocks allocated for the physical uplink shared channel, is lower than a threshold,
wherein the number of resource blocks is determined based on determining that the distance is lower than the threshold.

9. The apparatus according to any preceding claim, wherein the at least one frequency resource range comprises one frequency resource range corresponding to a bottom resource block or a top resource block of the allocated resource blocks of the physical uplink shared channel in frequency domain.

10. The apparatus according to any of claims 1-8, wherein the at least one frequency resource range comprises two frequency resource ranges,
wherein one frequency resource range of the two frequency resource ranges corresponds to a bottom resource block of the allocated resource blocks of the physical uplink shared channel in frequency domain,
wherein another frequency resource range of the two frequency resource ranges corresponds to a top resource block of the allocated resource blocks of the physical uplink shared channel in frequency domain.

11. The apparatus according to any preceding claim, further being caused to:
map low-priority uplink control information on the at least one frequency resource range.

12. The apparatus according to claim 11, wherein the low-priority uplink control information comprises channel state information part 2.

13. An apparatus comprising at least one processor, and at least one memory storing instructions that, when executed by the at least one processor, cause the apparatus at least to:
transmit, to a user device, an indication indicating to map uplink control information on a physical uplink shared channel at one or more slots, wherein the one or more slots are configured for a sub-band full duplex, SBFD, operation;
transmit, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and
receive, from the user device, the physical uplink shared channel, wherein at least a subset of the uplink control information is mapped on the physical uplink shared channel,
wherein the at least subset of the uplink control information is not mapped in the number of resource blocks.

14. The apparatus according to claim 13, further being caused to:
determine a cross link interference level associated with the physical uplink shared channel; and
determine, based on the cross link interference level being above a threshold, to transmit the indication indicating to map the uplink control information on the physical uplink shared channel.

15. An apparatus comprising:
means for receiving an indication indicating to map uplink control information on a physical uplink shared channel at one or more slots, wherein the one or more slots are configured for a sub-band full duplex, SBFD, operation;
means for determining, based on at least one default number of resource blocks or at least one scaling factor, a number of resource blocks in allocated resource blocks of the physical uplink shared channel that are within a pre-defined distance from one or more downlink subbands or one or more guard bands in frequency domain;
means for determining, based on the number of resource blocks, at least one frequency resource range where at least a subset of the uplink control information should not be mapped;
means for mapping the at least subset of the uplink control information on the physical uplink shared channel such that the at least subset of the uplink control information is not mapped to the at least one frequency resource range; and
means for transmitting the physical uplink shared channel according to the mapping at the one or more slots.

16. An apparatus comprising:
means for transmitting, to a user device, an indication indicating to map uplink control information on a physical uplink shared channel at one or more slots, wherein the one or more slots are configured for a sub-band full duplex, SBFD, operation;
means for transmitting, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and
means for receiving, from the user device, the physical uplink shared channel, wherein at least a subset of the uplink control information is mapped on the physical uplink shared channel,
wherein the at least subset of the uplink control information is not mapped in the number of resource blocks.

17. A method comprising:
receiving an indication indicating to map uplink control information on a physical uplink shared channel at one or more slots, wherein the one or more slots are configured for a sub-band full duplex, SBFD, operation;
determining, based on at least one default number of resource blocks or at least one scaling factor, a number of resource blocks in allocated resource blocks of the physical uplink shared channel that are within a pre-defined distance from one or more downlink subbands or one or more guard bands in frequency domain;
determining, based on the number of resource blocks, at least one frequency resource range where at least a subset of the uplink control information should not be mapped;
mapping the at least subset of the uplink control information on the physical uplink shared channel such that the at least subset of the uplink control information is not mapped to the at least one frequency resource range; and
transmitting the physical uplink shared channel according to the mapping at the one or more slots.

18. A method comprising:
transmitting, to a user device, an indication indicating to map uplink control information on a physical uplink shared channel at one or more slots, wherein the one or more slots are configured for a sub-band full duplex, SBFD, operation;
transmitting, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and
receiving, from the user device, the physical uplink shared channel, wherein at least a subset of the uplink control information is mapped on the physical uplink shared channel,
wherein the at least subset of the uplink control information is not mapped in the number of resource blocks.

19. A non-transitory computer readable medium comprising program instructions which, when executed by an apparatus, cause the apparatus to perform at least the following:
receiving an indication indicating to map uplink control information on a physical uplink shared channel at one or more slots, wherein the one or more slots are configured for a sub-band full duplex, SBFD, operation;
determining, based on at least one default number of resource blocks or at least one scaling factor, a number of resource blocks in allocated resource blocks of the physical uplink shared channel that are within a pre-defined distance from one or more downlink subbands or one or more guard bands in frequency domain;
determining, based on the number of resource blocks, at least one frequency resource range where at least a subset of the uplink control information should not be mapped;
mapping the at least subset of the uplink control information on the physical uplink shared channel such that the at least subset of the uplink control information is not mapped to the at least one frequency resource range; and
transmitting the physical uplink shared channel according to the mapping at the one or more slots.

20. A non-transitory computer readable medium comprising program instructions which, when executed by an apparatus, cause the apparatus to perform at least the following:
transmitting, to a user device, an indication indicating to map uplink control information on a physical uplink shared channel at one or more slots, wherein the one or more slots are configured for a sub-band full duplex, SBFD, operation;
transmitting, to the user device, an indication indicating at least one default number of resource blocks or at least one scaling factor for determining a number of resource blocks in allocated resource blocks of the physical uplink shared channel that are within a pre-defined distance from one or more downlink subbands or one or more guard bands in frequency domain; and
receiving, from the user device, the physical uplink shared channel, wherein at least a subset of the uplink control information is mapped on the physical uplink shared channel,
wherein the at least subset of the uplink control information is not mapped in the number of resource blocks.
